(19) United States
(12) Patent Application Publication
(10) Pub. No.: US 2006/0166045 A1
(43) Pub. Date: Jul. 27, 2006

(54) Fuel cell system and method for detecting running out of fuel in fuel cell

(75) Inventor: Okuyama Ryoichi, Osaka (JP)

Correspondence Address: THE WEBB LAW FIRM, P.C., 700 KOPPERS BUILDING, 436 SEVENTH AVENUE, PITTSBURGH, PA, 15219, US

(73) Assignee: GS YUASA CORPORATION, Kyoto-shi (JP)

(21) Appl. No.: 10/564,645

(22) PCT Filed: Mar. 22, 2004
(86) PCT No.: PCT/JP04/03887

§ 371 Date: Jan. 13, 2006

(30) Foreign Application Priority Data
Jul. 18, 2003 (JP) 2003-119337

(51) Int. Cl. H01M 16/00; H01M 8/04; H02J 7/32; H01M 10/46

(52) U.S. Cl. 429/9; 429/61; 429/22; 429/13; 320/101

(57) ABSTRACT

A secondary battery is connected to a fuel cell, the fuel cell is disconnected from a load when the output of the fuel cell falls, and the load is activated with the secondary battery. When the remaining capacity of the secondary battery decreases and becomes less than or equal to a first level, an indicator for indicating running out of fuel is turned on to require refueling. When the remaining capacity becomes less than or equal to a second level, the load is disconnected even from the secondary battery.

### BACKGROUND OF THE INVENTION

1. Field of the Invention

The present invention relates to a detection of running out of fuel in a fuel cell system, which uses a proton conductive solid polymer electrolyte.

2. Description of Related Art

Patent Literature 1: Japanese Patent Application Laid-open No. 2001-69610 (U.S. Pat. No. 6,672,415)

Patent Literature 1 discloses a fuel cell system in which a secondary battery as a backup supply is connected to a fuel cell, which uses a proton conductive solid polymer electrolyte. Such a fuel cell system is expected to be widely used for portable, household, business, and the like without limiting only for vehicle.

In a fuel cell system, a detection of a remaining amount of fuel is required. For the detection thereof, it is necessary to have a pressure sensor (for an H2 fuel) and a fuel sensor such as a level gauge (for a liquid fuel) or the like, which uses an ultrasonic sensor, a float, an optical sensor and the like. When the fuel cell system is for portable use or for household use, it is disadvantage in cost to provide the fuel sensor for detecting the remaining amount of fuel. In addition, when a cassette, a tank or the like which is detachably attachable and which is disposable is used for the supplying of a fuel, it is unrealistic to try installing the fuel sensor on the cassette or the tank.

### SUMMARY OF THE INVENTION

A main object of the present invention is to enable a detection of running out of fuel of a fuel cell without using a sensor for detection of remaining fuel.

Another object of the present invention is to enable early warning for exchanging a fuel cassette or for refueling.

A further object of the present invention is to enable use of a fuel cassette, the cassette being one which is not provided with a sensor for detection of a remaining fuel.

An aspect of the present invention is directed to a fuel cell system having a fuel cell, which uses a proton conductive solid polymer electrolyte, and a secondary battery as a backup supply, the fuel cell system including a device for monitoring an output of the fuel cell and connecting a load to the secondary battery when the output thereof decreases and becomes less than or equal to a predetermined value, and a device for monitoring a remaining capacity of the secondary battery and warning that the fuel cell is running out of fuel, when the remaining capacity decreases and becomes less than or equal to a predetermined value. For changing a connection from the fuel cell to the secondary battery, the output voltage of the fuel cell or the like, for example, may be monitored and thus the connection may be changed with a switch; or using a diode as a switch, the load may be connected to one of the fuel cell and the secondary battery the output of which is higher than the other.

Another aspect of the present invention is directed to a method for detecting running out of fuel in a fuel cell system having a fuel cell, which uses a proton conductive solid polymer electrolyte, and a secondary battery as a backup supply, the detection method including the steps of monitoring an output of the fuel cell without using a fuel sensor and connecting a load to the secondary battery when the output thereof decreases and becomes less than or equal to a predetermined value, and warning that the fuel cell is running out of fuel, when the remaining capacity of the secondary battery decreases and becomes less than or equal to a predetermined value.

In this invention, a fuel sensor is not necessary. Furthermore, in this invention, the load does not immediately stop at the time of running out of fuel since the load is capable of being activated with the secondary battery, when the output of the fuel cell has fallen due to running out of fuel or the like. In addition, warning that the fuel cell is running out of fuel is given when the remaining capacity of the secondary battery becomes less than or equal to a predetermined value, hence allowing a user to make a move such as an exchange of a fuel cassette, refueling, or the like before the load becomes inoperative. Moreover, the remaining capacity of the secondary battery is capable of being detected using the output voltage of the secondary battery, an internal impedance, a temperature rise, an integrated value for charge and discharge electrical quantities, and the like. Incidentally, a sensor for detecting the remaining capacity is standard equipment on the secondary battery.

It is preferable that the fuel cell system is provided with a device which detects a decrease in the output of the fuel cell, and a device which indicates a warning signal showing that the fuel cell is running out of fuel, when the load is connected to the secondary battery, whereby, for example, the warning signal for running out of fuel and a signal for running out of fuel which represents that the remaining capacity of the secondary battery decreases and becomes less than or equal to a predetermined value are indicated in such a way that a user can discriminate one signal from the other.

Carrying out what is described above makes it possible to give warning for running out of fuel while a sufficient capacity is still retained in the secondary battery, so that a user will be given enough time to make a move such as an exchange of a fuel cassette at his/her convenient time. For detecting an output decrease, the output of the fuel cell itself may be monitored or which one of the fuel cell and the secondary battery is connected to the load may be detected.

While a fuel may be a fuel gas such as hydrogen or one, which is obtained by processing a liquid fuel such as methanol using a reforming device, it is particularly important in the case of directly supplying a liquid fuel to the fuel cell. Among direct fuel cells, it is especially important in the case of supplying a liquid fuel from a fuel cassette which is detachably attachable since it becomes unacceptably costly to attach a fuel sensor such as a level gauge to the cassette which is also disposable. Therefore, it is preferable that the fuel cell is a direct fuel cell, the cell being one to which a liquid fuel is directly supplied, and the liquid fuel is supplied from a cassette which is detachably attachable. The cassette may be one, which serves as a fuel tank just as it is, or one, which is used for supplying a liquid fuel to a fuel tank on another member.

### BRIEF DESCRIPTION OF THE DRAWINGS

FIG. 1 is a block diagram showing a fuel cell system in an embodiment;

FIG. 2 is a flowchart showing a detection algorithm for detecting running out of fuel in the embodiment;

FIG. 3 is a flowchart showing a detection algorithm for detecting running out of fuel, which follows after the flowchart in FIG. 2; and

FIG. 4 is a schematic view showing operation characteristics of the fuel cell system of the embodiment.

### DESCRIPTION OF THE PREFERRED EMBODIMENTS

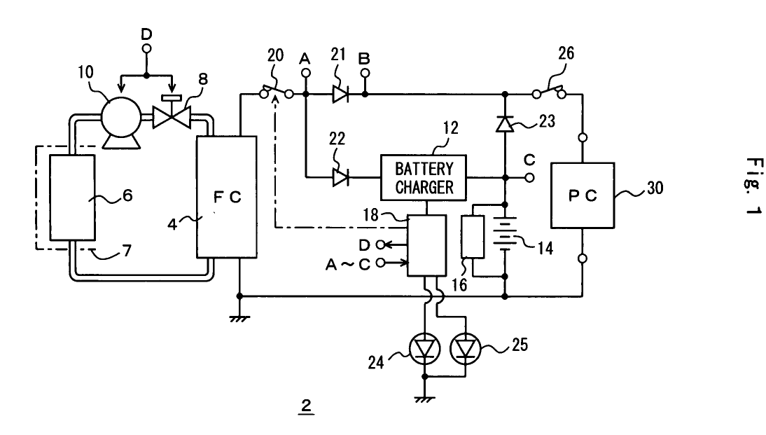

FIGS. 1 to 4 show a fuel cell system 2 in an embodiment. In the figures, reference numeral 4 is a fuel cell body. In the fuel cell body 4, a fuel electrode using Pt—Ru catalyst or the like and an air electrode using Pt catalyst or the like are provided on both sides of a proton conductive solid polymer electrolyte membrane. A fuel gas such as hydrogen and a liquid fuel such as a methanol-water mixed fuel are supplied to the side of the fuel electrode, while an oxidizing gas such as air is supplied to the side of the air electrode. A unit cell is formed by the solid polymer electrolyte membrane, the fuel electrode, and the air electrode; and a separator which supplies the fuel and the oxidizing gas thereto. A plurality of such unit cells is serially connected to form the fuel cell body 4 so as to produce a predetermined voltage.

Reference numeral 6 is a fuel cassette. The fuel cassette 6 stores a methanol-water mixed fuel for example on the order of 3 wt %, or a liquid fuel such as isopropanol-water or butanol-water. In the embodiment, the fuel cassette 6 was used as a liquid fuel tank just as it is. However, it is also possible to install the fuel cassette on a fuel tank not depicted in the figures and move a fuel into the tank. Furthermore, it is also possible to provide a storage cassette for storing a waste fuel other than the fuel cassette. Alternatively, it is possible to supply hydrogen from a hydrogen tank instead of the above-described liquid fuel or to supply hydrogen, which is obtained by reforming a liquid fuel in the fuel cassette 6 using a reforming device, to the fuel cell body 4. However, it should be noted that direct supply of a fuel to the fuel cell body 4 from the fuel cassette 6 is particularly important to a direct fuel cell system.

Reference numeral 7 is a cassette attachable-detachable mechanism, which allows the fuel cassette 6 to be detachably attachable. In addition, for example, the fuel cassette 6 may be disposable and may not be provided with a fuel sensor, which detects the liquid surface in the fuel cassette 6. Reference numeral 8 is a valve and reference numeral 10 is a fuel pump. When the valve 8 is opened, it causes the fuel pump 10 to be activated and thereby the fuel is supplied to the fuel cell body 4, thus generating electricity. In addition, it is also possible to provide an air pump, a recovery pump for waste fuel and the like. When these auxiliary pumps and auxiliary valves attached thereto are provided, the operations thereof are caused to be synchronized with those of the valve 8 and the fuel pump 10. Reference numeral 12 is a battery charger, which charges a secondary battery 14 with an output from the fuel cell body 4. However, the charging of the secondary battery 14 can be also performed using a commercial power through the battery charger 12 without using the output from the fuel cell body 4. Reference numeral 16 is a remaining capacity detection part, which detects the remaining capacity of the secondary battery 14 using an output voltage and an impedance of the secondary battery 14, a temperature change, an integrated value for charge and discharge electrical quantities, and the like. For the remaining capacity detection part 16, one which is standard equipment on a secondary battery 14 or on an electronic instrument with the secondary battery 14 may be used.

Reference numeral 18 is a control unit. In the case of starting the fuel cell system 2, the control unit 18 causes the valve 8 to be opened using the secondary battery 14, the fuel pump 10 to be actuated, and thereby causes the fuel cell body 4 to be activated. At the same time, a switch 26 is closed, and a load 30 of, for example, a hand-held personal computer or the like is activated with the secondary battery 14. When the fuel cell body 4 is activated and a predetermined period of time has elapsed, or when it is detected with a temperature change or the like that the fuel cell body 4 has reached a stable state, the fuel cell body 4 is connected to the load 30 through a protection switch 20. The secondary battery 14 is charged at an appropriate timing with the battery charger 12. The control unit 18 detects the output voltage of the fuel cell body 4 and the output voltage of the secondary battery 14 using potentials, for example, at the points A to C in FIG. 1. At the point A, the output voltage of the fuel cell body 4 is measured, at the point B a voltage which is applied to the load 30 is detected, and at the point C the output voltage of the secondary battery 14 is detected. When these potentials are inputted into the control unit 18, and voltage drops of diodes 21, 22, 23 and a voltage drop of the battery charger 12 are ignored, for example, the potential (V_{A}) at the point A >the potential (V_{C}) at the point C results in a current flow to the load 30 from the fuel cell body 4 and a charge current flow therefrom to the secondary battery 14. The potential (V_{A}) at the point A <the potential (V_{C}) at the point C results in a current flow to the load 30 from the secondary battery 14 and no charge current flow to the secondary battery 14. Hence, it is possible to monitor the operation conditions of the fuel cell body 4 and the secondary battery 14.

The diodes 21 to 23 are protection diodes. Particularly, when the diodes 21 and 22 are provided or at least the diode 21 is provided, the switch 20 needs not be provided. When the diode 21 is provided, a voltage which is obtained by subtracting a voltage for a level shift for the diode 21 from the output voltage of the fuel cell body 4, and a voltage which is obtained by subtracting a voltage for a level shift for the diode 23 from the output voltage of the secondary battery 14 are compared, and only one of the battery or the fuel cell body whose voltage is higher than the other is connected to the load 30. Furthermore, providing of the diode 22 enables to prevent of the current of the secondary battery 14 from flowing into the fuel cell body 4 through the battery charger 12, when the output of the fuel cell body 4 drops. However, when the battery charger 12 is one which is provided with a detection circuit for input voltage, the diode 22 is not necessary.

When the control unit 18 detects that the output of the fuel cell body 4 has dropped, it causes: the switch 20 to be opened; the fuel cell body 4 to be disconnected from the load 30; and current to be supplied to the load 30 from the secondary battery 14, and also causes: the valve 8 to be closed; the fuel pump 10 and the like to be stopped; and the fuel cell body 4 to be stopped (Signal D). When an air pump, a waste fuel recovery pump and the like are provided other than the fuel pump 10, these pumps are also caused to be stopped. In the detection of a decrease in the output, the output voltage of the fuel cell body 4 may be compensated by an amount of the load, and a running average or a maximum value within a predetermined time of the output voltage of the fuel cell body 4 may be used. With the diodes 21 and 23 provided, when the output voltage of the fuel cell body 4 decreases and the output voltage of the secondary battery 14 becomes higher than that of the fuel cell body 4, current flows to the load 30 from the secondary battery 14. Then, the fuel cell body 4 and the secondary battery 14 come to the state which is equivalent to be disconnected from each other. In this case, when the fuel cell body 4 is stopped due to a temporarily excessive load or the like, it is necessary to restart. Therefore, with the switch 20 being closed, the load 30 may be driven with one of the battery or the fuel cell body whose output voltage is higher than that of the other with the diodes 21 and 23. Moreover, when using the diodes 21 and 23, it is possible to connect in parallel the fuel cell body 4 and the secondary battery 14 while being in an excessive load, and thereby to drive the load 30.

The control unit 18 controls LED's 24 and 25 for indication for running out of fuel or the like, for example, with the LED 24 being in green color and the LED 25 being in red color. When the fuel cell body 4 is disconnected from the load 30, the control unit 18 causes the indication of the LED 24 to be changed from being on in green color to blink in green color so as to warn the necessity of refueling. At this time, the LED 25 in red color is put off. The secondary battery 14 is supposed to still have a remaining capacity to further operate the load 30. When the remaining capacity is detected by the remaining capacity detection part 16 and it decreases and becomes less than or equal to a first level, an indication for showing running out of fuel is turned on. For this indication, for example, the green LED 24 is turned off while the red LED 25 may be caused to blink. The remaining capacity detection part 16, further, continues monitoring the remaining capacity of the secondary battery 14 and, when it detects that the remaining capacity becomes less than or equal to a second level, the switch 26 is caused to be opened, hence disconnecting the load 30 from the secondary battery 14. Preferably, at the second level, a remaining capacity is greater than one which allows the fuel cell body 4 to restart, and at the first level, a remaining capacity is large enough to operate the load during, for example, about 10 minutes to 1 hour before the remaining capacity decreases and reaches the second level.

In the embodiment, although the LED's 24 and 25 are used for indicating running out of fuel and the like, it is possible to use an LCD or the like. Further, the indication may also be given in sound or through monitor display of a personal computer for the load 30. It is difficult, in the embodiment, to directly discriminate running out of fuel from the trouble of a fuel cell. For handling this matter, suppose for example that an indication, which indicates that the fuel cell is running out of fuel, is on, so refueling is performed and the fuel cell system 2 is restarted. When the indication indicating the running out of fuel does not turn off regardless of the restarting of the system 2 after refueling, the user then should be able to find out that the fuel cell is out of order.

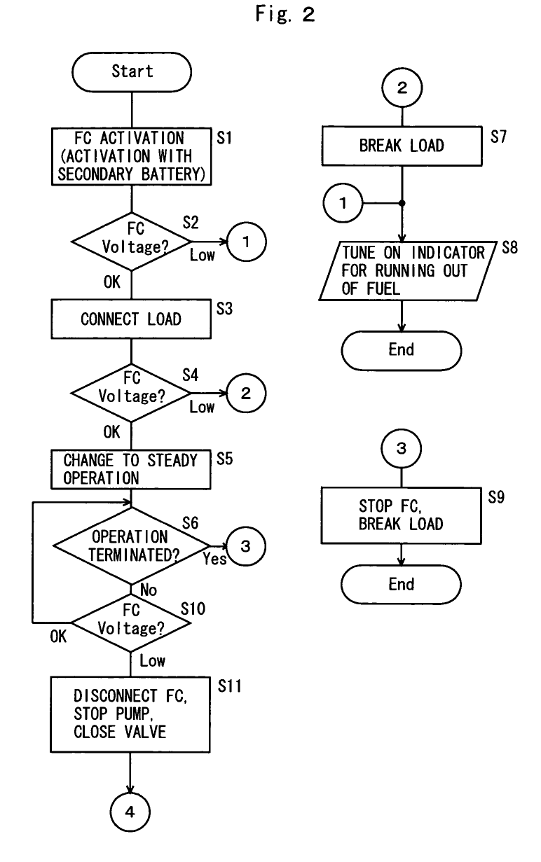

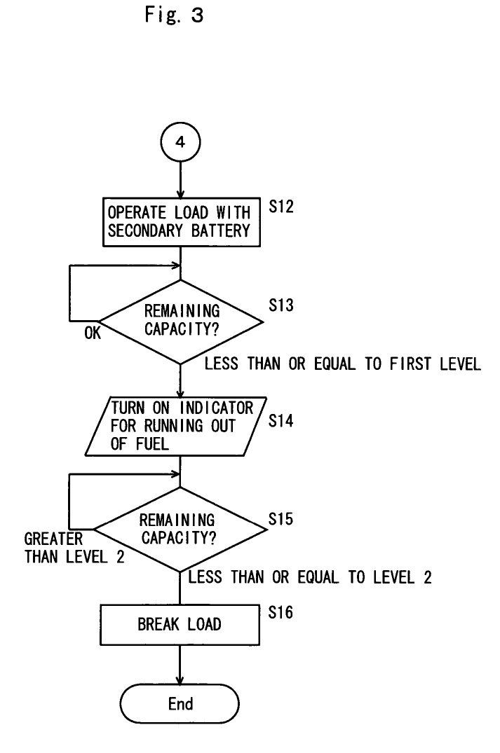

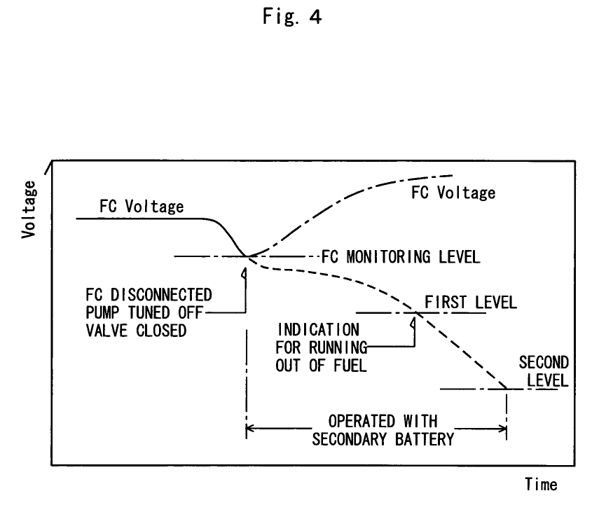

In FIGS. 2 to 4, FIGS. 2 and 3 show operation algorithms in the embodiment while FIG. 4 shows state changes based on the operation algorithms in FIGS. 2 and 3. When the fuel cell system 2 is activated, the valve 8 is caused to be opened with power for example from the secondary battery 14, and the pump 10 is activated, hence starting the fuel cell body 4 with the secondary battery 14 (Step 1). The system is put on hold for a predetermined period of time in the range of, for example, 30 seconds to 2 minutes after starting, and the output voltage (FC voltage) of the fuel cell body 4 is checked (Step 2). When the FC voltage is lower than a predetermined value, the process in Step 2 goes from a connector \textcircled{1} to Step 8, turning on an indication for running out of fuel, and is terminated. The checking of the output of the fuel cell body 4 at the time of starting may be carried out by monitoring an increase in temperature for the fuel cell body 4 instead of monitoring the FC voltage. However, the monitoring of the FC voltage enables omitting of a temperature sensor.

A load is connected (Step 3) after the FC voltage has reached a predetermined value and after the process has waited for a predetermined waiting time elapses. At this time, when the FC voltage becomes less than or equal to a predetermined value (Step 4), the process moves from a connector \textcircled{2} to Step 7, causing the load to be disconnected, the indicator for running out of fuel to be turned on, and is terminated. When the FC voltage, which is sufficiently high to activate the load, is obtained, the process moves onto a steady operation (Step 5). When the process is terminated halfway by a user's operation, it moves from Step 6 to a connector \textcircled{3}, causing the load to be disconnected, and the fuel cell is stopped (Step 9), for example, when the charging of the secondary battery 14 is not necessary. When the FC voltage decreases and becomes less than or equal to a monitoring level (Step 10) during the steady operation, the control unit 18 causes the fuel cell body 4 to be disconnected from the load and the like, the valve 8 to be closed, the pump 10 to be stopped, and causes the operation of the fuel cell to be stopped (Step 11). Thus, the FC voltage, for example, increases as shown with a dashed line in FIG. 4.

Even when the output of the fuel cell body 4 falls, there is supposed to be a remaining capacity in the secondary battery 14, so the load can be activated with the secondary battery 14 (Step 12). A voltage shown with a broken line in FIG. 4 is the output voltage of the secondary battery 14. In Steps 13 and 15, the remaining capacity is detected. When the remaining capacity decreases and becomes less than or equal to the first level, an indication for running out of fuel is turned on (Step 14) for requesting an exchange of a fuel cassette. When the remaining capacity decreases and becomes less than or equal to the second level, the load is disconnected and the operation of the fuel cell system is terminated (Step 16).

The fuel cell system of the present invention is especially important for a direct fuel cell system which uses a liquid fuel such as methanol-water as a fuel. The inventors found out a phenomenon where, when further operated a fuel cell whose output had already fallen, an Ru catalyst in a fuel electrode eluted into the fuel. This phenomenon occurred when, for example, the potential of the fuel electrode became greater than or equal to +500 mV to an air electrode. In addition, this phenomenon also occurred when a liquid fuel such as a methanol-water fuel was used as a fuel, while it did not occur when a hydrogen gas was used as a fuel. This phenomenon is irreversible; and, when the phenomenon occurred, the waste fuel turned black color and a large quantity of Ru was detected in the waste fuel.

In the direct fuel cell system which uses a methanol-water fuel or the like, a fuel electrode is exposed to acid electrolyte due to formic acid or the like which is produced by a partial oxidation of methanol. For a fuel electrode, a Pt—Ru composite catalyst is generally used to prevent CO poisoning; Incidentally, it is supposed that, when the potential of the fuel electrode becomes greater than or equal to +500 mV to an air electrode, it exceeds the elution potential of Ru and the Ru elutes into the fuel as electrolyte.

In the fuel cell body 4, since a plurality of unit cells are serially connected in general for activation, the aforementioned problem becomes more complicated. For example, when some of the unit cells are deficient in the supplying of the fuel, current is caused to flow to these unit cells with power from other unit cells. Consequently, the potential of the fuel electrode abnormally increases to the air electrode and Ru tends to elute. Therefore, the output voltage of the fuel cell body is monitored and the fuel cell body is halted when the output decreases and becomes less than or equal to a predetermined value, whereby the fuel cell is capable of being protected.

In the embodiment, running out of fuel is detected without using a fuel sensor or the like which detects a remaining amount of fuel and thus protection of the fuel cell becomes possible. It is, further, possible to activate the load even after fall of the output with the secondary battery as a backup supply, and indicate running out of fuel at an appropriate timing for requesting an exchange of the fuel cassette. In addition, in the embodiment, a type of battery, which is a lithium ion battery using for example hard carbon the output voltage of which greatly decreases in the end stage of discharge, was considered as the secondary battery 14. However, it is possible to use in the same manner other type of battery whose output voltage gradually decreases in the end stage of discharge, i.e. for example Ni-MH battery, a lithium ion battery using soft carbon, or the like, by detecting an integrated value for charge and discharge electrical quantities, a change in internal impedance, and a temperature rise.

1-4. (canceled)

5. A fuel cell system having a fuel cell, which uses a proton conductive solid polymer electrolyte, and a secondary battery as a backup supply, the system comprising:
a fuel cassette which is detachably attachable to the fuel cell;
means for monitoring an output of the fuel cell and, when the output of the fuel cell decreases and becomes less than or equal to a predetermined value, connecting a load to the secondary battery; and
means for monitoring a remaining capacity of the secondary battery and, when the remaining capacity decreases and becomes less than or equal to a predetermined value, warning that the fuel cell is running out of fuel.

6. The fuel cell system of claim 5, further comprising:
means for monitoring the output of the fuel cell and, when the output of the fuel cell decreases and becomes less than or equal to a predetermined value, disconnecting the load from the fuel cell and connecting the load to the secondary battery;
detecting means for detecting a decrease in the output of the fuel cell; and
means for indicating a warning signal showing that the fuel cell is running out of fuel when the detecting means has detected the decrease in the output of the fuel cell.

7. The fuel cell system of claim 5, further comprising means for warning that the fuel cell is running out of fuel when the remaining capacity of the secondary battery decreases and becomes less than or equal to a first level at which the load is capable of being operated for more than or equal to a predetermined period of time.

8. The fuel cell system of claim 7, further comprising means for disconnecting the load from the secondary battery when the remaining capacity of the secondary battery decreases and becomes less than the first level and becomes less than or equal to a second level at which the fuel cell is capable of being restarted.

9. The fuel cell system of claim 6, further comprising means for warning that the fuel cell is running out of fuel when the remaining capacity of the secondary battery decreases and becomes less than or equal to a first level at which the load is capable of being operated for more than or equal to a predetermined period of time.

10. The fuel cell system of claim 9, further comprising means for disconnecting the load from the secondary battery when the remaining capacity of the secondary battery decreases and becomes lower than the first level and becomes less than or equal to a second level at which the fuel cell is capable of being restarted.

11. A method for detecting running out of fuel in a fuel cell system having a fuel cell, which uses a proton conductive solid polymer electrolyte, and a secondary battery as a backup supply, comprising the steps of:
supplying a fuel from a fuel cassette which is detachably attachable to the fuel cell;
monitoring an output of the fuel cell without using a fuel sensor and, when the output of the fuel cell decreases and becomes less than or equal to a predetermined value, connecting a load to the secondary battery; and
warning that the fuel cell is running out of fuel when a remaining capacity of the second battery decreases and becomes less than or equal to a predetermined value.

12. The method for detecting running out of fuel in the fuel cell system of claim 11, further comprising the steps of:
monitoring the output of the fuel cell and, when the output of the fuel cell decreases and becomes less than or equal to a predetermined value, disconnecting the load from the fuel cell and connecting the load to the secondary battery;
detecting a decrease in the output of the fuel cell; and
indicating a warning signal showing that the fuel cell is running out of fuel when the decrease in the output of the fuel cell has been detected.

13. The method for detecting running out of fuel in the fuel cell system of claim 12, further comprising the step of warning that the fuel cell is running out of fuel when the remaining capacity of the secondary battery decreases and becomes less than or equal to a first level at which the load is capable of being operated for more than or equal to a predetermined period of time.

14. The method for detecting running out of fuel in the fuel cell system of claim 13, further comprising the step of disconnecting the load from the secondary battery when the remaining capacity of the secondary battery decreases and becomes less than the first level and becomes less than or equal to a second level at which the fuel cell is capable of being restarted.
